(19) United States
(12) Patent Application Publication
(10) Pub. No.: US 2013/0108044 A1
(43) Pub. Date: May 2, 2013

(54) Multi-Platform Communication System Providing Real-Time Point to Point Encrypted Communication

(71) Applicant: Paul Anthony Galwas, St. Ives (GB)

(72) Inventors: Paul Anthony Galwas, St. Ives (GB); Raph Weyman, Hemel (GB)

(73) Assignee: Cellcrypt Limited, London (GB)

(21) Appl. No.: 13/284,934

(22) Filed: Oct. 30, 2011

(51) Int. Cl. H04K 1/00

(52) U.S. Cl. 380/257

(57) ABSTRACT

A communication system providing point to point data encryption including one or more mobile end points, each mobile end point includes mobile equipment and an encryption module. The communication system also includes a network, a first gateway coupled to a Private Branch Exchange (PBX) telephone system, and a second gateway coupled to a Public Switch Networking System (PSTN). The PBX telephone system is connected to a telephone, a conference service and a voicemail service, and the PSTN is connected to a telephone. The network interconnects the one or more mobile end points, first gateway and the second gateway. The first gateway and second gateway each include an encryption module to provide seamless data encryption.

### FIELD OF THE INVENTION

The present disclosure relates to providing real-time encrypted communication, and more particularly to providing real time encrypted communication between end points of a multi-platform communication system.

### BACKGROUND OF THE INVENTION

There is an established field of real-time communications over Internet Protocol (IP) networks, which underpins widespread applications such as Voice over IP (VoIP). There are standard protocols such as Session Initiation Protocol (SIP) and Real-Time Transport Protocol (RTP) which support unencrypted real-time traffic. Secure RTP (SRTP) has been extended to encrypt real-time traffic.

Nevertheless, these mechanisms are not well suited to communication between mobile phones on General Packet Radio Service (GPRS), 3G Global Systems for Mobile Communication (GSM), HSPA and UMTS networks and Enhanced Data Rates for GSM Evolution (EDGE), where bandwidth is typically restricted and expensive, relative to wired networks. Furthermore, the aforementioned mechanisms are not well suited for encrypted communication between cellular networks and existing telephony systems, such as, Public Switched Telephone Network (PSTN) and Private Branch Exchange (PBX) telephone systems.

Accordingly, the disclosed methods and system are directed toward resolving the above noted problems with current encryption techniques.

### SUMMARY OF THE INVENTION

Exemplary embodiments disclosed herein provide an apparatus and method for real-time encrypted communication. The apparatus, for example, includes one or more mobile end points, wherein each mobile end point includes mobile equipment and an encryption module; an IP network, which may be a private network of an internet cloud; a first gateway coupled to a Private Branch Exchange (PBX) telephone system, wherein the PBX telephone system is connected to a telephone, a conferencing service and a voicemail service; a second gateway coupled to a Public Switch Networking System (PSTN), wherein the PSTN is connected to a telephone; the IP network interconnects the one or more mobile end points, the first gateway and the second gateway. The first gateway and second gateway each include encryption modules to effectuate seamless data encryption with the one or more mobile end points.

The method, for example, includes sending a request to initiate a call with an end point in a communication system; executing protocols to set up a call between two end points in the communication system; establishing a secure connection between the two end points; and encrypting data for transmission and transmitting the encrypted data over the secure connection.

### BRIEF DESCRIPTION OF THE DRAWINGS

FIG. 1 is a schematic diagram illustrating an exemplary embodiment of a communication system as disclosed herein.

FIG. 2 is a flow chart diagram illustrating an exemplary representation of an encrypted communication between two mobile end points.

FIG. 3 is a flow chart illustrating an exemplary representation of an encrypted communication between a mobile end point and a non-mobile end point.

### DETAILED DESCRIPTION

The present disclosure describes a communication system which provides point to point real time encrypted communication across heterogeneous bearer channels. The communication system provides point to point encrypted communication between, for example, two end points communicating over a GSM network, between an end point connected to a GSM network and an end point connected to a PBX telephony system, and between an end point connected to a GSM network and an end point connected to a Public Switched Telephone Network.

Although some of the exemplary embodiments are tailored to GSM, PSTN and PBX systems, the present invention is not limited to such systems, and can be used with other systems including Code Division Multiple Access (CDMA), 1× RTT and EV-DO, United States Time Division Multiple Access (US-TDMA) and Wi-Fi.

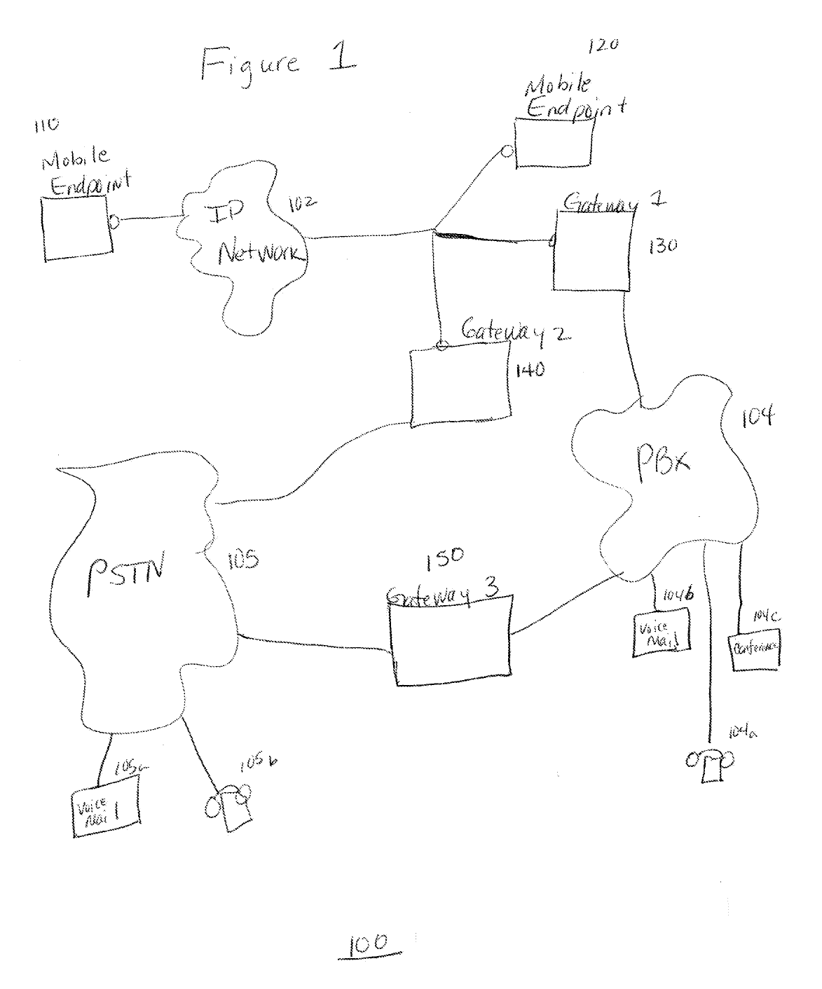

FIG. 1 is a diagram illustrating an exemplary system environment 100 for providing real time encrypted communication between end points in a communication system. In system environment 100, a network (e.g. network 102) interconnects mobile end-point 110, mobile end-point 120, gateway 130 and gateway 140. A PBX telephony system (e.g. PBX 104) is coupled to gateway 130 and gateway 150. A Public Switched Telephone Network (e.g., PSTN 105) is coupled to gateway 140 and gateway 150.

Network 102 is a wireless network system, such as, for example, GSM, EDGE, GPRS, 3G GSM, CDMA and Wi-Fi. The network may include one or more signaling servers and one or more media servers. An end point sends a request to the signaling server to make a call to another end point. The signaling server sets up the call, telling each end-point to contact the same media server. The end points send the real-time data to each other through the media server. The signaling server uses signaling protocols to establish and set up the call. The media server uses media protocols for receiving voice data and sending it across the network.

Mobile end points 110 and 120 are comprised of mobile equipment (e.g., mobile phone) equipped with encryption modules. The encryption modules provide encryption and decryption functions for voice data in real time and establish a secure communication link with another end point in the communication system. The encryption modules can be processors embedded with computer readable instructions that when executed perform encryption and decryption functions.

Gateways 130 and 140 are devices used to convert telephony traffic (e.g., PSTN or PBX) into an IP format for transmission over an IP network. Gateway 130 connects the traditional PBX phone system 104 to the IP network 102. Gateway 140 connects the PSTN 105 to IP network 102. Gateway 150 is a device used to convert telephony traffic between telephone systems (e.g. PBX and PSTN). Gateways 130 and 140 are equipped with encryption modules to facilitate encryption and decryption functions. Gateway 130 is arranged to provide transparent point to point encryption between a mobile end point (e.g., mobile end point 110) and gateway 130. Gateway 140 is arranged to provide transparent point to point encryption between a mobile point (e.g., mobile end point 110) and gateway 140, where it is sent in plain text to an end point of the PSTN 105 (e.g., telephone 105a).

In another exemplary embodiment of the present disclosure, gateway 130 decrypts the data received from an end point (e.g., mobile end point 110) and re-encrypts the data to transmit to suitable end points in the PBX 104.

In another exemplary embodiment of the present disclosure, end to end encryption is provided between a mobile end point (e.g., end point 110) and a telephone system (e.g., 104a or 105b).

In another exemplary embodiment of the present disclosure, calling groups may be associated with each gateway.

The encryption modules of system environment 100 may use redundant encryption schemes for session, authentication, digesting and/or key exchange. Preferred embodiments use two strong algorithms at the same time in series. The encryption of the data may be performed using any known cryptography algorithm, such as, for example, Elliptic curve Diffie-Hellman (ECDH), Rivest, Shamir and Adleman (RSA), Advanced Encyrption Standard (AES), Digital Signature Algorithm (DSA), etc.

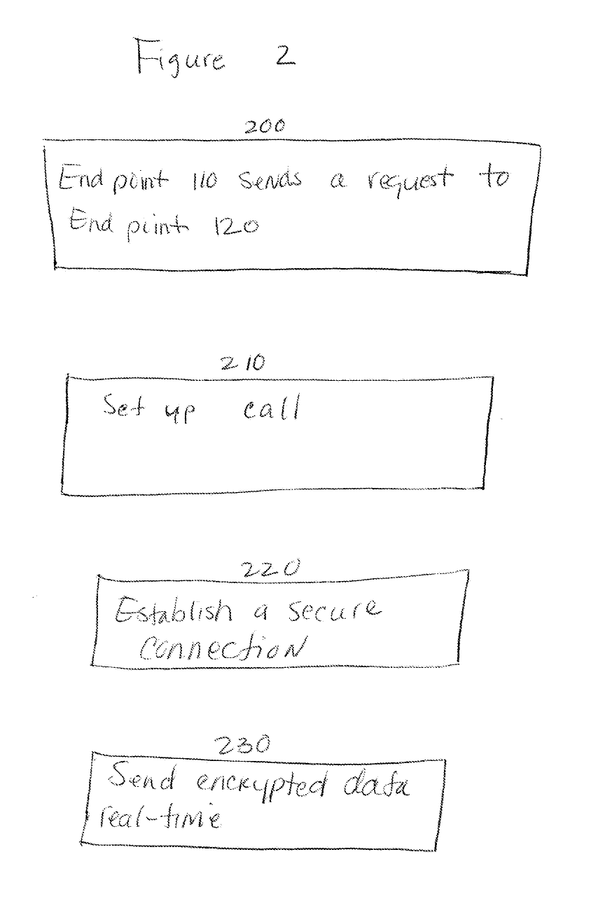

FIG. 2 is a flow chart illustrating the steps of an encrypted communication session between mobile end points 110 and 120. In step 200, end point 110 sends a request to the signaling server (not shown) to make a call to end point 120. At step 210, signaling server uses signaling protocols to set up a call between end points 110 and 120 (i.e. signaling server directs each end point to contact a same media server).

At step 220, a secure communication channel is established between end points 110 and 120 using the encryption modules embedded in each end point. The encryption module at end point 110 encrypts the data and the encrypted data is transferred in real time via the secure communication channel to end point 120, at step 230.

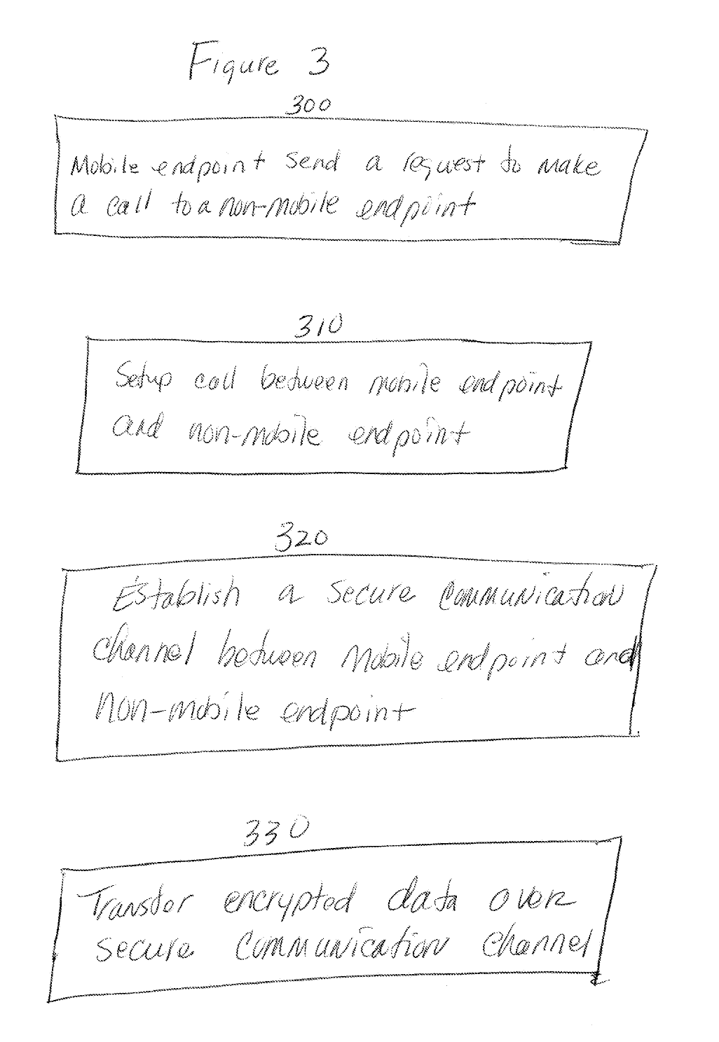

FIG. 3 is a flow chart illustrating the steps of an encrypted communication session between a mobile end point (e.g., 110) and a non-mobile end point (e.g., 130). In step 300, end point 110 sends a request to the signaling server (not shown) to make a call to end point 104a. At step 310, signaling server uses signaling protocols to set up a call between end point 110 and gateway 130.

At step 320, a secure communication channel is established between end point 110 and gateway 130 using the encryption modules embedded in the mobile end point and the gateway, respectively. Gateway 130 establishes a connection with the PBX telephony system 104 to transfer data to telephone 104a.

The encryption module at end point 110 encrypts the data and the encrypted data is transferred in real time via the secure communication channel to gateway 130, at step 330. Transparently, gateway 130 converts the encrypted data received from mobile end point 110 into a format suitable for the PBX telephone system, thereby, effectively providing point to point encrypted data communication across heterogeneous bearer channels. The converted encrypted data is subsequently transferred to telephone 104a.

Point to point encrypted data communication between mobile end point 110 and non-mobile end point 140 occurs in a manner similar to that shown in FIG. 3.

As disclosed herein, embodiments and features of the invention can be implemented through computer hardware and/or software. Such embodiments can be implemented in various environments, such as networked and computing-based environments. The present invention is not limited to such examples, and embodiments of the invention can be implemented with other platforms and in other environments.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

What is claimed:

1. A communication system providing point to point data encryption comprising:
one or more mobile end points, wherein each mobile end point comprises mobile equipment and an encryption module;
a network;
a first gateway coupled to a Private Branch Exchange (PBX) telephone system, wherein the PBX telephone system is connected to a telephone, a conference service and a voicemail service;
a second gateway coupled to a Public Switch Networking System (PSTN), wherein the PSTN is connected to a telephone;
the network interconnects said one or more mobile end points, said first gateway and said second gateway, and wherein the first gateway and second gateway comprise encryption modules to effectuate seamless data encryption with said one or more mobile end points.

2. The communication system of claim 1, wherein the network is an Internet Protocol (IP) network.

3. The communication system of claim 1, wherein the network is selected from a group comprising GSM, EDGE, 3G GSM and CDMA.

4. The communication system of claim 1, wherein the network comprises one or more signaling servers.

5. The communication system of claim 4, wherein the signaling servers use signaling protocols to establish and set up a call between mobile end points.

6. The communication system of claim 1, wherein the network comprises one or more media servers.

7. The communication system of claim 6, wherein the one or more media servers use media protocols for receiving voice data and sending the data across the network.

8. The communication system of claim 1, wherein the encryption modules located within the mobile end points and the gateways all operate to perform real-time point to point encryption.

9. A method of providing point to point encrypted data communication comprising the steps of:
sending a request from an end point to initiate a call with another end point in a communication system;
executing protocols, by a network, to set up a call between said end point and said another end point in said communication system;
establishing, by the communication system, a secure connection between said end point and said another two end point; and
encrypting data, by one or more encryption modules, for transmission and transmitting the encrypted data over the secure connection.

10. The method of claim 9, wherein the one or more encryption modules use redundant encryption schemes.

11. The method of claim 9, wherein the step of establishing a secure connection between the end points includes authenticating the end points.

12. The method of claim 9, wherein the encryption modules perform encryption using a cryptography algorithm selected from a group comprising Elliptic Curve Diffie-Hellman (ECDH), Rivest, Shamir and Adleman (RSA), Advanced Encryption Standard (AES) and Digital Signature Algorithm (DSA).

13. The method of claim 9, wherein the network uses signaling protocols to set up a call between end points.

14. The method of claim 9, wherein the network uses media protocols for receiving and transmitting data.

15. The method of claim 9, wherein the data encryption is performed in real time.
